(19) United States
(12) Patent Application Publication
(10) Pub. No.: US 2025/0106449 A1
(43) Pub. Date: Mar. 27, 2025

(54) SYSTEM AND METHOD FOR DYNAMICALLY MODIFYING MEDIA CONTENT IN A VIDEO EDITING ENVIRONMENT

(71) Applicant: GRASS VALLEY LIMITED, Newbury, Berkshire (GB)

(72) Inventor: James Westland CAIN, Newbury, Berkshire (GB)

(21) Appl. No.: 18/853,004

(22) PCT Filed: Mar. 28, 2023
(86) PCT No.: PCT/IB2023/053098

§ 371 Date: Sep. 30, 2024

Related U.S. Application Data
(60) Provisional application No. 63/362,026, filed on Mar. 28, 2022.

(51) Int. Cl. H04N 21/2343; H04N 21/239

(52) U.S. Cl. CPC H04N 21/2343; H04N 21/2393

(57) ABSTRACT

A system is provided for dynamically modifying media content before delivery to a content consumption device. The system includes a database that store access metadata that indicates access information for media assets and media location metadata for identifying a location of each of the media assets in a repository. A media processing database receives media content manipulation functions to modify parameters of media content and assigns a unique identification to each of the functions. A cloud resource database includes metadata for available cloud resources. A content delivery manager receives a request to dynamically manipulate and deliver a modified media content, determines a desired function based on the unique identification, locates an available cloud resource to modify the parameter, and controls the located resource to decompress and execute the desired media content manipulation function to generate a modified media content that is delivered to the client device to be displayed thereon.

### TECHNICAL FIELD

The system and method disclosed herein is related to media production, and, more particularly, to a system and method for dynamically modifying media content before delivery to a content consumption device for media production and editing.

### BACKGROUND

Media production and/or video editing typically involves capturing media content from one or a plurality of live scenes (e.g., a sports venue, news broadcast, video game platforms, and the like), transmitting the captured content to a remote production facility where the video and audio signals are managed by production switchers, graphics effects are added, and the like, and then the processed signals are encoded for transport to a distribution network, such as a television broadcasting network, through one or a plurality of signals. More recently, broadcasting and media production has evolved from analog to digital domain and across various protocols (e.g., MPEG-2 transport streams, Internet Protocol (IP), IPTV, HTTP streaming). In IP technology, there are myriad tools, software code bases, and the like, that present an infinite set of combinations, or development efforts, which lead to a final “product” (e.g., a media production) through execution of media production workflows that incorporate these tools.

With the continuous growth, development and accessibility of cloud computing platforms and networks, such as Amazon Web Service® (“AWS”), many of the processing components involved in a typical media production environment to generate the final product are being moved to “the cloud” and/or being distributed broadly across a number of geographical locations. In the cloud, infrastructure as code (IAC) and configuration as code (CAC) provide for a dynamic infrastructure that is effectively a software defined processing capability that enables software execution of each desired task at hand. In this case, code modules may be assigned identity, compilers for the code are assigned identity, the IAC and CAC are assigned identity, and the like, to execute these tasks.

However, even with the dynamic software defined processing capabilities that these cloud computing environments present, certain functions of processing the media must still be performed on a case by case basis and on the client devices, rather than in the cloud. Therefore, a problem exists in how to identify and optimize resources of the computing environments to efficiently and economically execute processing functions for video editing and media production before the content is actually delivered to client devices in a video editing environment.

### SUMMARY OF THE INVENTION

Accordingly, a system and method are provided for dynamically modifying media content before delivery to a content consumption device for media production and editing.

In an exemplary aspect, a system and method are provided to stream media content to third-party editors (e.g., Adobe Premiere®, Avid Media Composer® and the like). As the system and method decompress that media in a plugin, it can pass through a media modification function (e.g., a color conversion step), without the client application being aware of this function before it is ultimately offered to the APIs of the client application. Moreover, the system and method can vary the color mapping over time, and as directors improve the look of their media, all users in the media production environment will automatically receive the updated look from the central cloud control. Effectively, the systems and methods described herein are processing the media before making it available to the third-party editing systems. Moreover, color manipulation is just one of a number of processes that could be applied in this space, and that other media manipulation functions, such as watermarking or stamping the name of the user into the decompressed frames, can be performed to stop the images from being shared on the Internet, for example.

According to an exemplary embodiment, a system is provided for dynamically modifying media content before delivery to a content consumption device. In this aspect, the system includes a media essence repository configured to store a plurality of media assets; a media essence access database configured to store access metadata that indicates access information for the plurality of media assets, including media location metadata for identifying a location of each of the plurality of media asset in the media essence repository; a media processing database configured to receive a plurality of media content manipulation functions for modifying at least one aspect of media content and further configured to assign a unique identification to each of the plurality of media content manipulation functions; and a cloud resource database comprising metadata associated with a plurality of resources available in a cloud computing network that includes both physical resources and software resources, with the resources comprising a plurality of processors and electronic memory accessible by the plurality of processors.

Moreover, in the exemplary system a content delivery manager is provided and configured to receive a request from a client device to dynamically manipulate and deliver a modified media content to the client device, access a media asset of the plurality of media assets in the media essence repository based on the corresponding access information in the media essence access database that is obtained by a media content identification in the request from the client device, determine a desired media content manipulation function of the plurality of media content manipulation functions based on the unique identification in the media processing database that is accessed in response to the request from the client device, locate an available resource of the plurality of resources available in the cloud computing network for executing the desired media content manipulation function to modify the at least one parameter of the accessed media content, and control the located available resource to decompress and execute the desired media content manipulation function to generate a modified media content that is delivered to an application programming interface (API) of the client device to be displayed thereon.

In a variation of the exemplary aspect, the plurality of processors includes at least one of a computer processing unit (CPU), a graphics processing unit (GPU), and a field programmable gate array (FPGA). Moreover, the plurality of media content manipulation functions can include a color transform being at least one of a mathematical, algorithmic and heuristic function. Yet further, the plurality of media assets comprise at least one media stream having a plurality of video frames, such that the desired media content manipulation function modifies the at least one parameter of the accessed media content on a frame by frame basis before the modified media content is delivered to the API of the client device. Finally, the media processing database is further configured to dynamically update the plurality of media content manipulation functions in response to adjustments of modification parameters of each media content manipulation function.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplary pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a block diagram of a system for dynamically modifying media content before delivery to a content consumption device according to an exemplary embodiment.

FIG. 2 illustrates a block diagram of a system for dynamically modifying media content before delivery to a content consumption device according to an exemplary embodiment.

FIG. 3 illustrates a more detailed block diagram of a media content dynamic modification system for modifying media content before delivery to a content consumption device according to an exemplary embodiment.

FIG. 4 illustrates a block diagram of a system for dynamically modifying media content before delivery to a content consumption device according to an exemplary embodiment.

FIG. 5 illustrates a block diagram of a content delivery manager system for dynamically modifying media content before delivery to a content consumption device according to an exemplary embodiment.

FIG. 6 illustrates a flowchart for a method for dynamically modifying media content before delivery to a content consumption device according to an exemplary embodiment.

FIG. 7 is a block diagram illustrating a computer system on which aspects of systems and methods for dynamically modifying media content before delivery to a content consumption device according to an exemplary embodiment.

### DETAILED DESCRIPTION

Various aspects of the invention are now described with reference to the drawings, wherein like reference numerals are used to refer to like elements throughout. In the following description, for purposes of explanation, numerous specific details are set forth in order to promote a thorough understanding of one or more aspects of the invention. It may be evident in some or all instances, however, that any aspects described below can be practiced without adopting the specific design details described below. In other instances, well-known structures and devices are shown in block diagram form in order to facilitate description of one or more aspects. The following presents a simplified summary of one or more aspects of the invention in order to provide a basic understanding thereof.

In general, certain aspects of the dynamic media modification system will now be presented with reference to various systems and methods. These systems and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

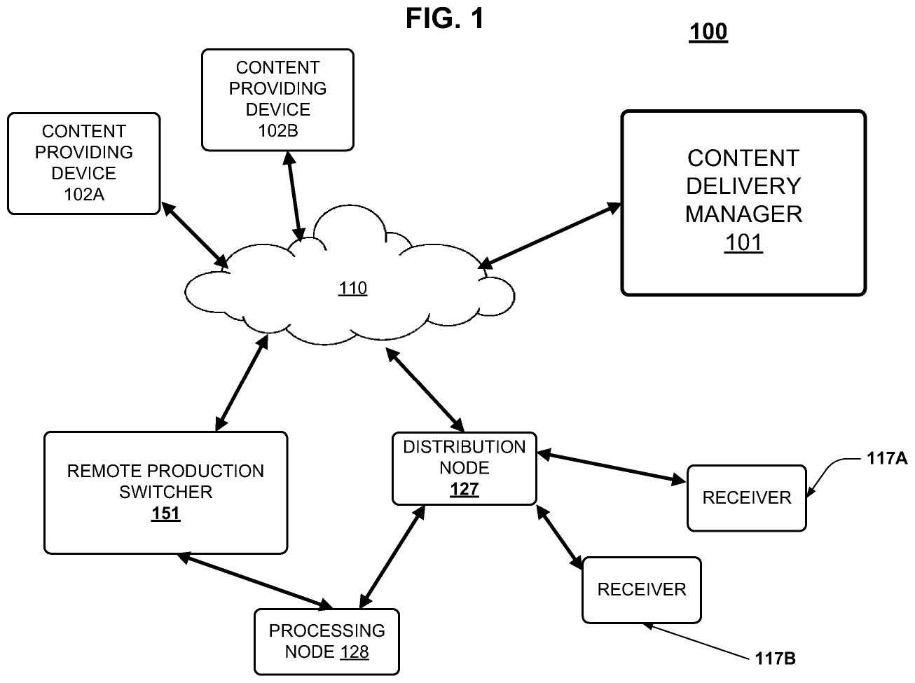

FIG. 1 illustrates a block diagram of a system for dynamically modifying media content before delivery to a content consumption device according to an exemplary embodiment. As will be described in detail below, the exemplary system 100 can include a design interface tool (e.g., a computer-aided design (CAD) software tool and user interface) that is configured to request media content that can be dynamically processed before it is delivered to a client device, e.g., as part of a workflow in a media production environment. In general, media content provided for production according to system 100 is generally referred to as “essence”, which denotes media (e.g., a video clip, an audio clip, and/or ancillary data such as captions) that can be consumed by a client consumption device/client device. As will be described in detail herein, the content delivery management system enables dynamic deployment of processing functions, such as color transform functions, to the cloud for performing such processing functions on the media essence before it is delivered to the client device.

As shown, the system 100 includes a content delivery manager 101, which is the software tool or module (e.g., implemented on one or more computer processing devices) that is configured to manage the dynamic modification of media content in a cloud computing environment according to the algorithms and techniques described herein. Moreover, FIG. 1 illustrate a block diagram of a system that is specific to a media production environment. As described above, the content delivery manager 101 is configured to deploy a function (e.g., a color transform function) as a component(s) or node(s) before the modified media content is delivered to a client device. Thus, the content delivery manager 101 can generally be located remotely from all of the other components in the system and, in some embodiments, coupled to the components (which are part of a cloud computing environment/network) to effectively deploy and apply the function to the media content. Thus, the components shown in system 100 are provided as an exemplary system.

In an exemplary aspect, the processing function can be a color transform, including one or more of a mathematical function, an algorithmic function or a heuristic function. In general, a media production may be shot over a few weeks with different lighting (e.g., due to cloudy and sunny environment, etc.). Thus, color conversion functions can be generated to modify the media content to have a same hue, or a same “look”, regardless the actual lighting conditions when the media content was actually captured.

Moreover, as will be described in greater detailed below, the content delivery manager 101 can, in response to a client request for media content, decompress the media content and pass it through a color conversion function before it is delivered to the application programming interface (API) of the client device. Effectively, the color conversion is performed in a cloud environment and before it is delivered to the client device without the client application even being aware that that the content delivery manager 101 is dynamically modifying the content in this way. Moreover, the client device can be, for example, a client device of a media production environment executing a video editing application for the media production using the modified content. Advantageously, the system can dynamically vary the color mapping over time as directors of the media production environment improve the look of the media content, such that all users of this content as part of the media production receive the updated look from central cloud control “automagically”.

It should also be appreciated that while color transform/manipulation is described as an exemplary aspect of the embodiment, the content delivery manager 101 can be configured to control and dynamically deploy a number of different media processing functions in this space, such as watermarking or stamping the name of a user into the decompressed frames to stop the images being shared on the Internet, for example. In addition, each function can be decomposed to one or more atomic compute functions, such that there is no reentry of data to the function (i.e., the deployed function is stateless). In other words, the media modification function can be decomposed into one or more atomic compute functions that can be deployed on one or more processing components of the cloud network. Moreover, the content delivery manager 101 can be configured to determine an optimal deployment (e.g., mutate the machine and/or select different machines) to meet the requirements of the media manipulation function while optimizing the memory load for the stated function.

Referring back to FIG. 1, system 100 includes a plurality of content providing devices 102A and 102B, which can be configured for an A/V feed across links via the network 110. Moreover, it is noted that while only two devices are shown, the system 100 can be implemented using a single content providing device or many content providing devices. In one exemplary aspect, the plurality of content providing devices 102A and 102B can also include, for example, remote cameras configured to capture live media content, such as the “talent” (e.g., news broadcasters, game commentators, or the like). Moreover, the content providing devices 102A and 102B can include Esports (e.g., electronic sports) real-time content, or the like. In general, it should be appreciated that while the exemplary aspect uses content providing devices 102A and 102B (which may be located at a live event, for example), a similar configuration can be used for any type of content providing device, such as a remote video server (e.g., a media essence repository), for example, that is configured to cache the media content after it is captured and distribute this cached content through the media distribution network.

As further shown, the plurality of content providing devices 102A and 102B can be coupled to a communication network 110, such as the Internet, and/or hardware conducive to internet protocol (IP). That is, system 100 can be comprised of a network of network servers and network devices configured to transmit and receive video and audio signals (e.g., media essence) of various formats. In an exemplary aspect, the communication network 110 and processing components thereof can be executed in a cloud computing environment/network. Moreover, in one aspect, essence, such as video content, that is generated (or otherwise provided) by the content providing devices 102A and 102B is provided as an input data set for the media modification function deployed to the cloud as described herein.

In general, cloud computing environments or cloud platforms are a virtualization and central management of data center resources configured as software-defined pools. Cloud computing provides the ability to apply abstracted compute, storage, and network resources to the work packages provided on a number of hardware nodes that are clustered together forming the cloud. Moreover, the plurality of nodes each have their specialization, e.g., for running client micro-services, storage, and backup. A management software layer for the application platform offered by the cloud will typically be provided on a hardware node and will include a virtual environment manager component that starts the virtual environments for the platform and can include micro-services and containers, for example. As will be described in detail below, the content delivery manager 101 is configured to access metadata for the plurality of cloud computing resources available for the media production workflow and control a media modification function (e.g., a color conversion) for the media production.

In any event, as yet further shown, system 100 can include one or more remote distribution node(s) 127, one or more processing node(s) 128, and one or more remote production switcher(s) 151. As noted above, these components can be implemented as hardware components at various geographical locations or, in the alternative, as processing components as part of the cloud computing environment 101. The one or more distribution nodes 127 (e.g., electronic devices) are configured to distribute the modified media content to one or more distributed nodes (e.g., remote media devices), such as receivers 117A and 117B, which can be content consuming devices (e.g., video editing software on client computing devices, or the like), for example. Moreover, it should be appreciated that while only two receivers 117A and 117B are shown, the network can include any number of content consuming devices configured to receive and consume (e.g., playout) the media content, with such content consuming devices even being distributed across different countries or even different continents.

In this network, distribution node(s) 127 can further be configured to distribute the media content throughout the distribution network to one or more processing node(s) 128, which may include a mix/effects engine, keyer or the like. Examples of processing node(s) 128 may include remote production switches similar to remote production switcher 151 or remote signal processors and can be included in the cloud computing environment in an exemplary aspect. As described in detail below, processing node 128 (and/or distribution node 127 or remote production switcher 151) can be selected by the content delivery manager 101 to execute the color transform function of the media content before it is delivered to APIs of the applications running on receivers 117A and 117B.

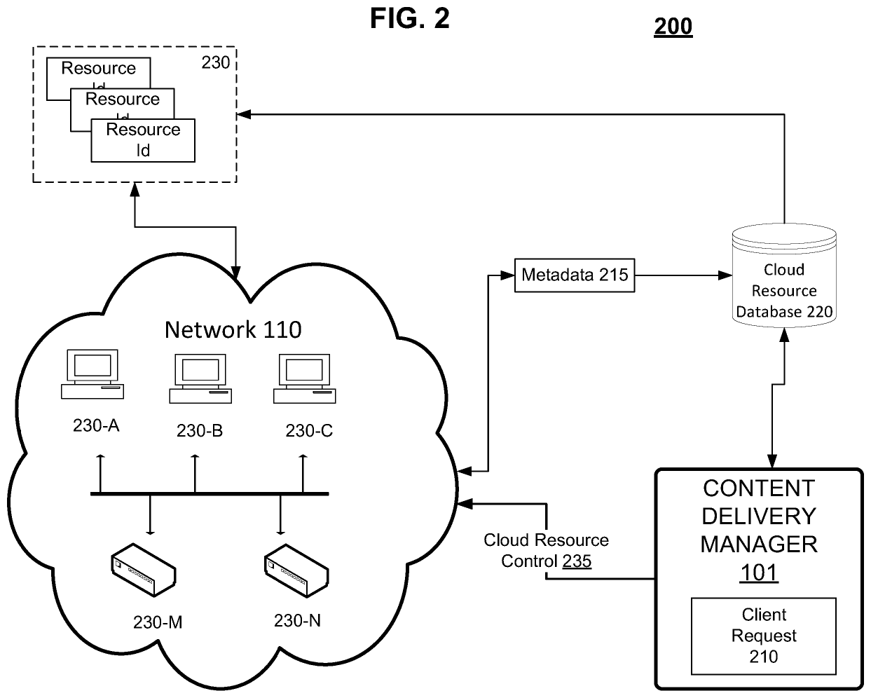

FIG. 2 illustrates a block diagram of a system 200 for dynamically modifying media content before delivery to a content consumption device according to an exemplary embodiment. In particular, it should be appreciated that FIG. 2 illustrates a more detailed block diagram system 200 that includes the content delivery manager 101 and cloud computing network 110 of system 100. That is, system 200 illustrates a more detailed subset of the components of system 100 in an exemplary aspect.

As described above, the content delivery manager 101 can be implemented on a computer or similar computing device. Moreover, the content delivery manager 101 is coupled to a cloud resource database 220. The cloud resource database 220 can be configured as a media processing resource database that receives metadata 215 from the cloud computing network 110. This metadata 215 identifies available resources in the cloud computing network 110 that can include, for example, both physical resources and software resources as described above.

According to the exemplary embodiment, the content delivery manager 101 first receives a request from a client device, such as client request 210. In particular, this client request 210 can be generated by a user interface of a software editing application that requests a particular set of media content (e.g., a sequence of video frame from captured media content) and also specify a particular “look” (e.g., a color conversion) to be applied the requested media content. In one aspect, the client request 210 can specify the “look” based on a user defined parameter, which includes a unique identification of the required “look” to be applied to the media content. In turn, the content delivery manager 101 receives the client request 210 from the client device in order to dynamically manipulate and deliver the modified media content to the requesting client device.

In general, it is noted that while the exemplary aspect describes user defined parameters to dynamically modify the media content to obtain a “look”, it should be appreciated that the requested media modification function can more broadly apply to the processing (e.g., modification or manipulation) of any type of aspect or characteristic for processing the media content. For example, a “look” broadly has a number of aspects each of which may contribute to the final composition of the modified media content. User defined parameter(s), settings and/or adjustments may be implemented using the algorithms described herein to achieve the stated function for generating the modified media content.

In a related aspect, the requesting client device can be one of a plurality of collective devices as part of a media production team. In this way, the director of the media content can predesignate the look for a given production, which specifies a required color conversion to be applied to all media content for that production. In turn, the application of each requesting device can be preconfigured to include the same unique identification for this look. As a result, each requesting client device of the media production will automatically receive the media content with the same applied modifications (e.g., color conversions to the video frames), as will be discussed in more detail below.

In either event, upon receiving the client request 210 with the unique identification of a requested “look”, the content delivery manager 101 is configured to determine a desired media content manipulation function based on the unique identification, and, in turn, locate an available resource of the plurality of resources available in the cloud computing network for executing the desired media content manipulation function to modify one or more parameters of the accessed media content. In particular, the content delivery manager 101 using the unique identification is configured to query the cloud resource database 220 to determine the available resources that are configurable and available to execute the desired function according to defined requirements/criteria to provide the client device with the modified media content. To do so, resource identifiers 230 may also be provided from the cloud computing network 110 to the cloud resource database 220 and can be returned to the content delivery manager 101 so the content delivery manager 101 can control and allocate the requested media modification function to complete the desired task for satisfying user requirements in the client request 210. In exemplary aspects, the resource identifiers 230 may include metadata descriptors of the type of resource, a make of the resource, capabilities of the resource, usage parameters and availabilities (including time) for the resource, network location and other linked resources. In exemplary aspects, the resource type may be physical (e.g., a computing device, mobile device, microchip, or other internet connected device, or the like), software based (e.g., a software application, a software service, a cloud computing platform, or the like), or the like. The capabilities of the resource enable the content delivery manager 101 to deploy the media modification function to meet the requirements, for example, as a cloud resource control instruction 235.

An illustrative set of resources 230-A to 230-N is shown in FIG. 2 and represents exemplary available resources in cloud computing network 110. In an aspect, each resource 230-A to 230-C and 230-M to 230-N can be a device (either tangible or virtual) that has a resource ID 230, that is associated with a respective resources and which has a unique relationship to its respective metadata 215. The resource IDs 230 can be stored remotely in a cloud computing environment (e.g., as shown by dashed lines of 130) and/or directly stored by the resources 230-A to 230-N themselves, for example. In either case, the device IDs 230 are associated with the metadata for each respective resources 230-A to 230-N. As will be discussed in more detail below, the processing can be performed local to the content consumption. In other words, one or more of the respective resources 230-A to 230-N can actually be identified as a resource at the same client device that is generating the client request 210.

According to an exemplary aspect, resources 230-A to 230-C are a plurality of processing devices configurable for executing the media modification functions of the selected media content and resources 230-M to 230-N are accessible memory (e.g., RAM, cache or the like) that can be accessed by the plurality of processing devices to execute the requested function. In a refinement of the exemplary aspect, resource 230-A is at least one computer processing unit (CPU), resource 230-B is at least one graphics processing unit (GPU), and resource 230-C is at least one field programmable gate array (FPGA). It should be appreciated that the resources can be any combination of these components in various exemplary aspects.

According to the exemplary embodiment, the metadata 215 (including capabilities and availabilities) is dynamically provided to cloud resource database 220. For example, the cloud resource database 220 can be configured to query a list of available resources (e.g., resources 230-A to 230-N) in which each resource is being linked to and shares its unique identity. In one aspect, the unique identity can be an attribute filed in its metadata record. In another exemplary aspect, the unique identity for a resource can be composed of a number of logically grouped identities.

In another exemplary aspect, a list of resource locators is provided to the cloud resource database 220, which is configured to communicate with the resources to receive metadata records that are associated with the unique resource ID for that resource. Alternatively, in some aspects, a resource may be smart, connected to the Internet (for example in the cloud environment), and may be configured to submit metadata information to listening servers, submitted to the cloud resource database 220. The collected (or otherwise provided) metadata 215 is stored in cloud resource database 220. Once a request to find and deploy a media manipulation function to one or more resources in the cloud computing network 110 is generated, the content delivery manager 101 is invoked to retrieve resource IDs 230 to determine available and relevant resources for executing the processing function.

In an exemplary aspect of the present disclosure, the content delivery manager 101 can be configured to establish a unique identify for each of the resources whose metadata is collected, the identity establishing the capabilities and capacity of the given resource. In one example, the unique identity for IoT or other connected devices can be assigned by a process, similar to DHCP (dynamic host configuration protocol). For example, a physical device could provide its MAC address, or, alternatively, a virtual device could provide a unique address based upon the port MAC and the served IP address. The AMWA IS-05 specification uses LLDP as a way to initiate a connection, and create a unique ID for a virtual resource. It should be appreciated that there is no loss of generality with such method when considering transient devices: one which are spun up, and then later spun down. Accordingly, actual deployment and configuration of the available resource by the content delivery manager 101 can be executed using these known techniques in an exemplary aspect.

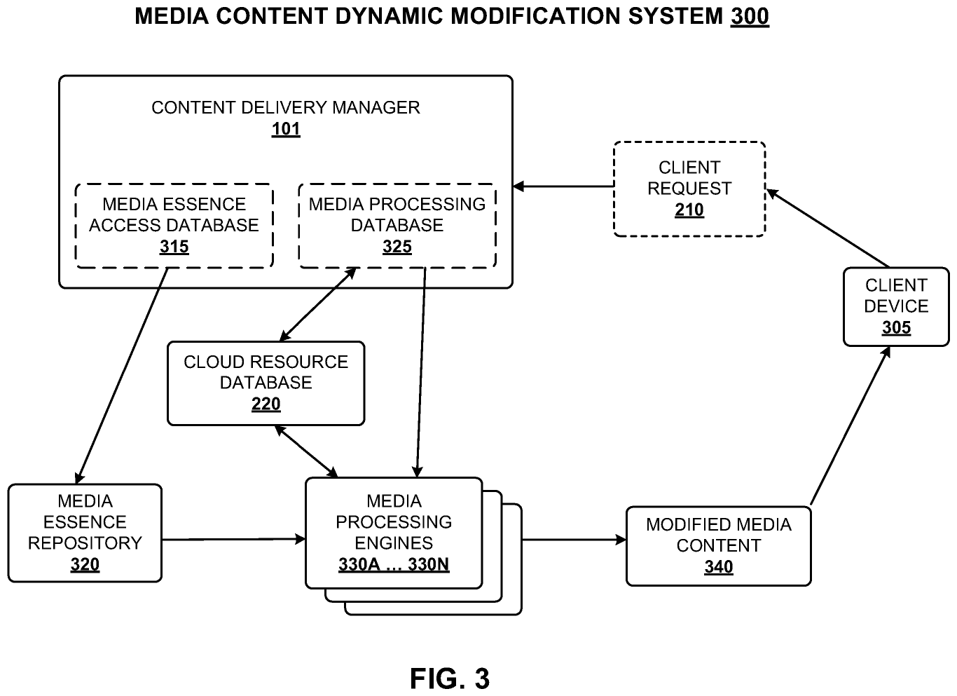

FIG. 3 illustrates a more detailed block diagram of a media content dynamic modification system for modifying media content before delivery to a content consumption device according to an exemplary embodiment. It should again be appreciated that FIG. 3 illustrates a more detailed block diagram system 100 that includes the content delivery manager 101 and otherwise provides a more detailed subset of the components of system 100 in an exemplary aspect. In this regard, the client device 305 can correspond to either of receivers 117A and/or 117B as described above with respect to FIG. 1 that transmit a client request 210 to content delivery manager 101, which designates a request for specific media content and also a request for execution of a media modification function (e.g., a color conversion process). It should be appreciated that in an alternative aspect, the requesting color conversion (e.g., the requested “look”) can be predesignated by a director and that the client request 210 can be associated with a particular media production associated with that director. In other words, any request for media content in a client request 210 that is associated with the particular media production will be designated to receive modified media content having the same color conversion for that media production, as specified by the director.

As further shown in FIG. 3, the system 300 includes a media essence repository 320 that is configured to store a plurality of media assets, such as sequences of video and audio content. In one aspect, the media essence repository 320 can be a video server, for example, and/or can correspond to one or more of content providing devices 102A and 102B as described above with respect to FIG. 1. The content delivery manager 101 can further include a media essence access database 315, which can be a standalone database communicatively coupled to content delivery manager 101 in one exemplary aspect. Here, the media essence access database 315 is configured to store access metadata that indicates access information (e.g., media location metadata) for identifying each of the plurality of media assets in the media essence repository 320, including, for example, a track number and range of each of the plurality of media asset. That is, the client request 210 can specify the requested media content which can be accessed by the content delivery manager 101 using the media access database which uses media request information to lookup up the location of the media in the media essence repository 320. In one aspect, this request can be made by an API of the client application on a client device, as described in U.S. patent application Ser. No. 16/569,323, filed Sep. 12, 2019, the entire contents of which are hereby incorporated by reference.

As further shown, the media content dynamic modification system 300 can include a media processing database 325 that is configured to receive a plurality of media content manipulation functions (e.g., color conversion functions) for modifying at least one parameter of the requested media content. In particular, during the course of a media production, a director may continue to dynamically adjust color conversion parameters (e.g., “looks”) to be applied to a set of media content. These looks (e.g., color transform matrices or algorithms) can be uploaded, for example, as “recipes”, periodically by a director to the content delivery manager 101, which can be configured to store and dynamically update the “looks” in the media processing database 325. In an exemplary aspect, the media processing database 325 can pull the recipes periodically from the director or the director can push these recipes of media modification functions that are constructed to modify one or more parameters of the media content. Moreover, the recipe enables to the content delivery manager 101 to look up and determine which function is applied and/or add a dynamic range to the media content, before applying a color conversion matrix to achieve the desired “look”. Effectively, the director can continue to develop and revise any desired look for a given media production that is managed by the content delivery manager 101 in a cloud-based environment. As a result, each requesting client API will automatically receive the modified media content with the current “recipe” applied to the media content to achieve the desired look.

To do so, the media processing database 325 can also be configured to assign a unique identification to each of the plurality of these media content manipulation functions, e.g., the recipes are each assigned unique identifications. Using these unique identifications, the content delivery manager 101 can look up the desired look (e.g., the recipe) to be applied the requested media content based on the requested look as it is specified in the client request 210.

In addition, the media content dynamic modification system 300 includes cloud resource database 220, which corresponds to the database 220 described above with respect to FIG. 2. As described above, the cloud resource database 220 can receive stored metadata 215 that is associated with the plurality of resources (e.g., devices 230-A to 230-N) that are available in a cloud computing network 110 that includes both physical resources and software resources. Based on the requested media manipulation function (e.g., the color conversion as specified in the client request 210), the content delivery manager 101 can be configured to identify one or more processing engines or nodes (e.g., media processing nodes 330-A to 330-N) using the metadata 215 set forth in the cloud resource database 220 to identify the particular resource(s) that is available to perform the requested function and which resource is optimal to do so. For example, if the requested media manipulation function is a color conversion as discussed above, the content delivery manager can be configured to identify an available GPU as the one or more media processing engines 330-A to 330-N to perform the requested processing function on the one or more parameters of the media asset(s). This modified media content 340 is then dynamically delivered to the client device 305. An example of a system and method for selecting one of a plurality of resources (e.g., devices 230-A to 230-N) for performing a required function is described in U.S. Pat. No. 11,138,042, entitled “System and Method of Identifying Equivalents for Task Completion”, and issued Oct. 5, 2021, the entire contents of which are hereby incorporated by reference. Thus, the content delivery manager 101 can select one or more of a plurality of resources (e.g., devices 230-A to 230-N) using the algorithms disclosed therein according to exemplary aspects.

As noted above, the processing can be performed local to the content consumption in an exemplary aspect. More particularly, the client device 305 can be identified as the resource for performing the selected functions. This means that the selected media (e.g., from media essence repository 320) can be downloaded to the client device 305 once, but the system can be configured to dynamically adapt the transfer function on different viewings by only transmitting the new maths (i.e., the current requested media manipulation function) and not the changed media. Thus, in this exemplary aspect, one or more of media processing engines 330A to 330N can effectively be embedded into the client device 305, such that the modified media content 340 is made locally to client device 305.

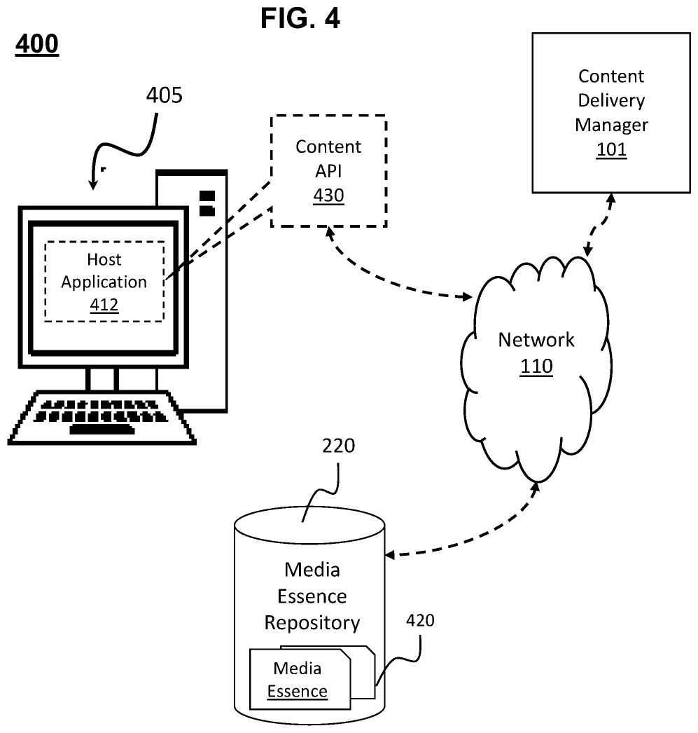

FIG. 4 illustrates a block diagram of a system 400 for dynamically modifying media content before delivery to a content consumption device according to an exemplary embodiment. In this aspect, the client device 405 is located remotely from and connected to network 110 and can correspond either of receivers 117A and/or 117B in an exemplary aspect. Moreover, client device 405 can be executing, for example, a host application 412, such as a video editing software (e.g., Adobe Premiere® or Avid Media Composer®) that can be configured to edit video content as part of a media production as described herein. In this aspect, the host application 412 can include a content API 430 that is configured to transmit a request (e.g., client request 210) to access modified media content. Based on the request, the content delivery manager 101 can be configured to stream the manipulated media content from the media essence repository 220 as described above. In particular, as the media essence 420 is pulled from cache of the media essence repository 220, it is decompressed (e.g., in a plugin of the content delivery manager 101) where it passes through a colour conversion step before it is offered to the content API 430. This is done without the client application 412 being aware that the color conversion is being executed.

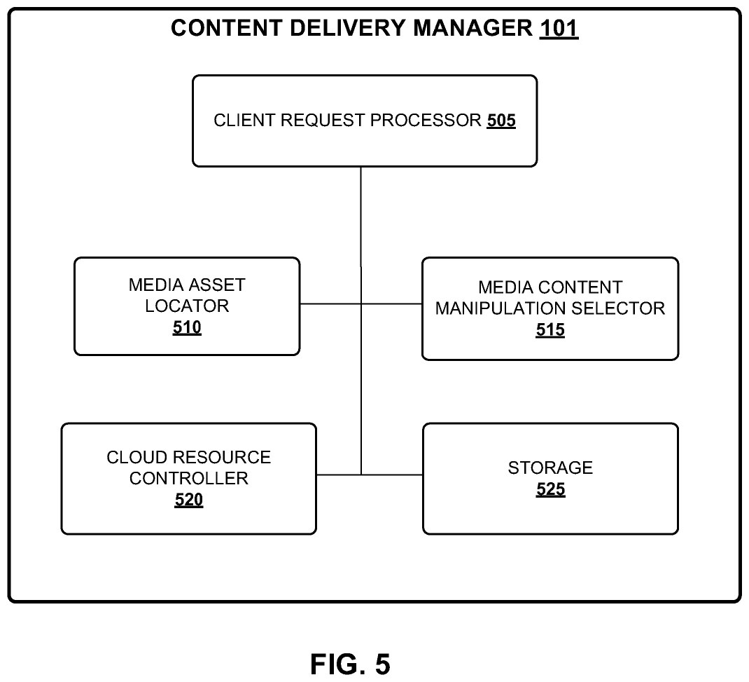

FIG. 5 illustrates a block diagram of a content delivery manager 101 for dynamically modifying media content before delivery to a content consumption device according to an exemplary embodiment. As described above, the content delivery manager 101 can be implemented on one or more computing devices that is communicatively coupled to the network 110 for media production and/or video editing as shown above. Moreover, the content delivery manager 101 includes a plurality of components and/or modules for executing the algorithms and techniques described herein.

More specifically, the content delivery manager 101 includes a client request processor 505, media asset locator 510, media content manipulation selector 515, cloud resource controller 520 and storage 525. In general, the storage 525 can be implemented as electronic memory configured to store the one or more of the media processing functions in media processing database 325, the metadata 215 in media essence access database 315, and/or the like. Moreover, each of these components can be implemented as software engines or modules configured for executing the algorithms disclosed herein.

In general, each of the client request processor 505, media asset locator 510, media content manipulation selector 515, and cloud resource controller 520 can be implemented as one or more modules. The term “module” as used herein can refer to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor of a general purpose computer. Accordingly, each module can be realized in a variety of suitable configurations, and should not be limited to any example implementation exemplified herein.

As described above, the content delivery manager 101 is configured receiver media content requests from an API of a client device and decompress the accessed media content, passing it through a media manipulation/modification function (e.g., a color conversion) before it is delivered to the client device. In operation, the client request processor 505 is configured to receive a request (e.g., client request 210) from a client device (e.g., device 305 or 405) to dynamically manipulate and deliver a modified media content to the client device. Based on the content identification information, the media asset locator 510 can be configured to access a media asset of the plurality of media assets in the media essence repository 320 based on the corresponding access information in the media essence access database 315 that is obtained by a media content identification in the request 210 from the client device 305, as described in detail above.

Moreover, the media content manipulation selector 515 is configured to determine a desired media content manipulation function (e.g., a color conversion function) of the plurality of media content manipulation functions that may be stored in media processing database 325. This determination may be based on a unique identification in the media processing database 325 that is accessed in response to the client request 210 from the client device 305. That is, the request may be preconfigured with an identification of the required “look” to be performed to one or more parameters of the requested media content. In turn, a cloud resource controller 520 is configured to locate an available resource of the plurality of resources (e.g., media processing engines 330-A to 330N) available in the cloud computing network 110 for executing the desired media content manipulation function to modify the one or more parameters of the accessed media content. In this regard, the cloud resource controller 520 can further be controlled to select the resource using cloud resource database 220 and then control the located available resource to decompress and execute the desired media content manipulation function to generate the modified media content that is delivered to the requesting API of the client device 305/405 to be displayed thereon, for media editing functions as part of a video production, for example. In an exemplary aspect, the cloud resource controller 520 controls the one or more resources by cloud resource control signals 235 as described above with respect to FIG. 2.

Thus, according to an exemplary aspect, the content delivery manager 101 can be configured to determine deployment criteria for the media manipulation function that includes an input dataset (e.g., the selected media asset) for the processing function and at least one atomic compute function (e.g., a mathematical, algorithmic and heuristic function) for executing the processing function on the media asset. In other words, the deployment criteria can define the type of input data (e.g., one frame, a plurality of lines of pixel data, or the like) and a required time (e.g., a time threshold) for computing the task.

Based on the deployment criteria, the cloud resource controller 520 is configured to control, based on the determined criteria, one or more media processing engines 330-A to 330N, which can be considered a processing node 128 of FIG. 1 in an exemplary aspect. In other words, the cloud resource controller 520 is configured to identify the available resource within the network 110 using the resource IDs 230 and metadata 215, as described above, and to control this resource to deploy and execute the requested function on the media asset. In general, the different selected resources will offer different outcomes for the user and the workflow, but for executing the same function. For example, a first group of selected resources may offer a faster execution (e.g., parallel processing using a plurality of GPU) at a higher cost, whereas a second selected group of resources may offer a slower execution (e.g., less GPUs), but also at a lower economic cost for the workflow.

In an exemplary aspect, in the cloud, the cloud resource controller 520 may select a CPU, a GPU or an FPGA, or a combination thereof, for a selected function for the requested media asset(s) and can do so using various techniques as would be appreciated to one skilled in the art. For example, in one aspect, IAC and CAC enables porting (or “lift and shift”) that effectively migrates the selected media manipulation function to the cloud platform (which includes the media production processing components described above). In turn, the cloud computing platform can receive the request and dynamically modify the configurations for performing the selected function in response to the request from the cloud resource controller 520. In an alternative aspect, the selected media manipulation function can be configured as one or more containers within the cloud platform, such that the cloud resource controller 520 is configured to generate a new container for each selected function, e.g., each color conversion of the selected media asset. This new container can then be provided to the cloud platform 110. The control and deployment of such functions to the selected resources is generally shown as cloud resource control signals 235 of FIG. 2 described above.

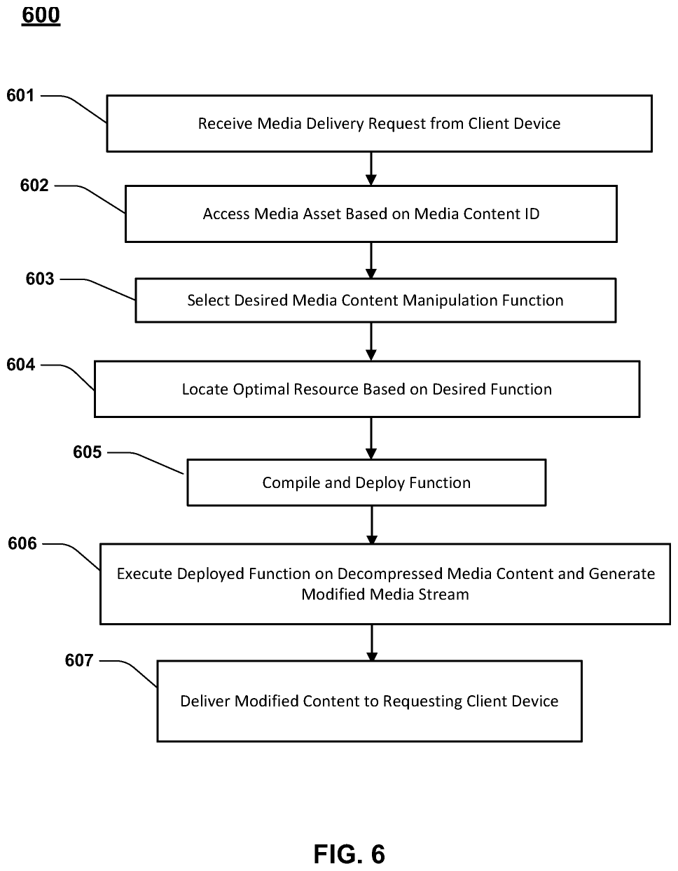

FIG. 6 illustrates a flowchart for a method for dynamically modifying media content before delivery to a content consumption device according to an exemplary embodiment. In general, it should be appreciated that the method 600 can be executed using one or more of the components described above with respect to FIGS. 1-5. Moreover, the method 600 will be described in general terms of the content delivery manager 101, but it should be appreciated that the steps of the described method can be executed using one or more of the specific modules of the content delivery manager 101 as described above.

As shown, the method begins at Step 601 when the content delivery manager 101 receives a client request from an API of a client device (e.g., client device 305) for delivering a media asset, such as a sequence of video frames for video editing, which can be part of a media production, for example. At Step 602, the content delivery manager 101 accesses the requested media asset and can decompress the content for performing a media modification function, such as a color conversion or transform function. The media modification function is then selected by the content delivery manager 101 at Step 603, which can be performed in sequence or in parallel with Step 602.

Next, at Step 604, the content delivery manager 101 can select a cloud resource (e.g., processing node 128 of FIG. 1) to deploy and execute the selected function. The function is compiled and deployed to the resource at Step 605. Before delivering the content to the requesting client device, it is decompressed at Step 606 and the selected resource executes the deployed function, which can be performed on a frame by frame basis at step 606. In an exemplary aspect, the media modification function can be applied as a look-up table (“LUT”) in which the media content is decompressed and applied to matrices of the LUT to perform the color conversion process as known to those skilled in the art.

Finally, the modified content is then delivered to the requesting client device at Step 607. As a result, the content delivery manager 101 can dynamically load and modify media content that is delivered to a requesting client device, without the client device having any knowledge or requiring any further processing to perform such a function. In the context of color conversion for a large-scale media production, each video editing application can receive media content processed and modified by the same processing function (e.g., color conversion) to provide the same “look”. This processing eliminates to perform the color conversion and updating that is currently required in such media production environments.

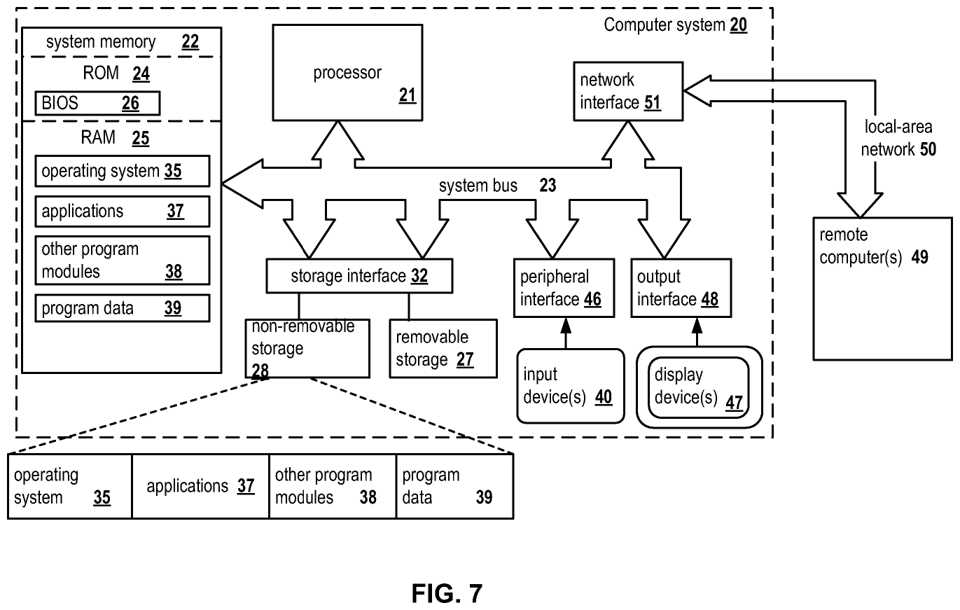

FIG. 7 is a block diagram illustrating a computer system on which aspects of systems and methods for dynamically modifying media content before delivery to a content consumption device according to an exemplary embodiment. It should be noted that the computer system 20 can correspond to the system 100 or any components therein, including, for example, content delivery manager 101. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) can include a single or multiple sets of processors having single or multiple cores. The processor 21 may execute one or more computer-executable codes implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces. In an exemplary aspect, the one or more remote computers 49 can correspond to the cloud computing network 110, as well as one or more of the various components shown in FIGS. 1-5 as described above.

In general, exemplar aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A system for dynamically modifying media content before delivery to a content consumption device, the system comprising:
a media essence repository configured to store a plurality of media assets;
a media essence access database configured to store access metadata that indicates access information for the plurality of media assets, including a media location metadata for identifying a location of each of the plurality of media assets in the media essence repository;
a media processing database configured to receive a plurality of media content manipulation functions for modifying at least one parameter of media content and further configured to assign a unique identification to each of the plurality of media content manipulation functions;
a cloud resource database comprising metadata associated with a plurality of resources available in a cloud computing network that includes both physical resources and software resources, with the resources comprising a plurality of processors and electronic memory accessible by the plurality of processors;
a content delivery manager configured to:
receive a request from a client device to dynamically manipulate and deliver a modified media content to the client device,
access a media asset of the plurality of media assets in the media essence repository based on the corresponding access information in the media essence access database that is obtained by a media content identification in the request from the client device,
determine a desired media content manipulation function of the plurality of media content manipulation functions based on the unique identification in the media processing database that is accessed in response to the request from the client device,
locate an available resource of the plurality of resources available in the cloud computing network for executing the desired media content manipulation function to modify the at least one parameter of the accessed media content, and
control the located available resource to decompress and execute the desired media content manipulation function to generate a modified media content that is delivered to an application programming interface (API) of the client device to be displayed thereon.

2. The system according to claim 1, wherein the plurality of processors includes at least one of a computer processing unit (CPU), a graphics processing unit (GPU), and a field programmable gate array (FPGA).

3. The system according to claim 2, wherein the plurality of media content manipulation functions include a color transform being at least one of a mathematical, algorithmic and heuristic function.

4. The system according to claim 3, wherein the plurality of media assets comprise at least one media stream having a plurality of video frames, such that the desired media content manipulation function modifies the at least one aspect of the accessed media content on a frame by frame basis before the modified media content is delivered to the API of the client device, and

[symbol]

5. The system according to claim 1, wherein the media processing database is further configured to dynamically update the plurality of media content manipulation functions in response to adjustments of modification aspects of each media content manipulation function.
